(19) United States
(12) Patent Application Publication
(10) Pub. No.: US 2021/0258732 A1
(43) Pub. Date: Aug. 19, 2021

(54) Mobile Phone Location Tracking Device

(71) Applicant: Jerry W. Robinson, New Orleans, LA (US)

(72) Inventor: Jerry W. Robinson, New Orleans, LA (US)

(21) Appl. No.: 17/176,630

(22) Filed: Feb. 16, 2021

Related U.S. Application Data
(60) Provisional application No. 62/977,448, filed on Feb. 17, 2020.

(51) Int. Cl. H04W 4/029; H04W 4/024; G08B 21/18; G08B 3/00

(52) U.S. Cl. CPC H04W 4/029; G08B 3/00; G08B 21/182; H04W 4/024

(57) ABSTRACT

A mobile phone location tracking device is presented. The device includes a housing having a wireless transceiver disposed therein, wherein the wireless transceiver is in operable communication with a mobile device. A GPS unit within the housing operably connects to a mobile GPS unit within the mobile device via the wireless transceiver to monitor a threshold separation distance between the mobile device and the housing. Upon detection that the housing has exceeded the threshold separation distance from the mobile device, a speaker within the housing emits an audible alert. In some embodiments, the mobile device emits an audible alert as well. A power source is disposed within the housing and is operably connected to each of the speaker, the wireless transceiver, and the GPS unit.

### CROSS REFERENCE TO RELATED APPLICATIONS

This application claims the benefit of U.S. Provisional Application No. 62/977,448 filed on Feb. 17, 2020. The above identified patent application is herein incorporated by reference in its entirety to provide continuity of disclosure.

### BACKGROUND OF THE INVENTION

The present invention relates to mobile phone location devices. More particularly, the present invention pertains to a mobile phone location tracking device that emits an audible alert upon detection of exceeding a threshold separation distance between the device and an associated mobile phone.

Many individuals are increasingly attached to the mobile phones as they become ever more capable of a variety of useful tasks. In recent years, individuals may feel distressed if unable to readily access their mobile phone, losing the capability of communication with others, portable entertainment, or information gathering. As mobile phones are designed with a focus on portability, this often results in phones becoming smaller, sleeker, or more easily misplaced. Additionally, many individuals may simply forget to pick up their mobile phone before leaving an area. This can be particularly problematic in public spaces, as the mobile phone may become permanently lost. Furthermore, misplacing a mobile phone may pose a security risk, providing personal information to others that may be used for identity theft or other harmful activities. Therefore, a device that can be easily carried to alert the user when they have stepped away from their mobile phone by a predetermined threshold distance is desired.

In light of the devices disclosed in the known art, it is submitted that the present invention substantially diverges in design elements from the known art and consequently it is clear that there is a need in the art for an improvement to existing mobile phone tracking devices. In this regard, the instant invention substantially fulfills these needs.

### SUMMARY OF THE INVENTION

In view of the foregoing disadvantages inherent in the known types of mobile phone tracking devices now present in the known art, the present invention provides a mobile phone tracking device wherein the same can be utilized for providing convenience for the user for notifying the user that the mobile device has exceeded a threshold separation distance between the tracking housing and the mobile device.

The present system comprises a housing having a wireless transceiver disposed therein, wherein the wireless transceiver is in operably communication with a mobile device. A GPS unit is disposed within the housing, wherein the GPS unit is configured to operably connect to a mobile GPS unit disposed within the mobile device via the wireless transceiver to monitor a threshold separation distance between the mobile device and the housing. In some embodiments, the housing is in operably communication with a mobile application installed on the mobile device, wherein the mobile application is configured to monitor the threshold separation distance between the housing and the mobile device. Upon detection that the housing has exceeded the threshold separation distance from the mobile device, a speaker within the housing emits an audible alert. In some embodiments, the mobile device may emit an audible alert upon detection of the housing exceeding the threshold separation distance. A power source is disposed within the housing and is operably connected to each of the speaker, the wireless transceiver, and the GPS unit.

In some embodiments, a display screen is disposed on the housing, wherein the display screen is configured to display a map showing a current location of each of the housing and the mobile device as determined by the GPS unit and the mobile GPS unit, respectively. In another embodiment, a control button is disposed on the housing, wherein the display screen is activated to display the map upon actuation of the control button. In other embodiments, the display screen comprises a touch-sensitive display, wherein the control button comprises a digital control button displayed on the display screen. In yet another embodiment, a distance control is disposed on the housing, wherein the distance control is configured to selectively adjust a size of the threshold separation distance. In some embodiments, the distance control comprises a sliding switch disposed on a lateral side of the housing. In another embodiment, the housing further comprises an aperture therethrough, wherein a key chain connector is disposed through the aperture. In other embodiments, the mobile application further comprises a distance control, wherein the distance control is configured to selectively adjust a sue of the threshold separation distance. In yet another embodiment, the mobile application further comprises a sound selector, wherein the sound selector is configured to selectively adjust the sound of the audible alert emitted from the speaker of the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mobile phone tracking device.

FIG. 2 shows a front view of the display screen of an alternate embodiment of the mobile phone tracking device.

FIG. 3 shows a front view of a mobile application associated with an embodiment of the mobile phone tracking device.

FIG. 4 shows a schematic view of an embodiment of the mobile phone tracking device.

### DETAILED DESCRIPTION OF THE INVENTION

Reference is made herein to the attached drawings. Like reference numerals are used throughout the drawings to depict like or similar elements of the mobile phone tracking device. The figures are Intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “electronic device” or “mobile device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

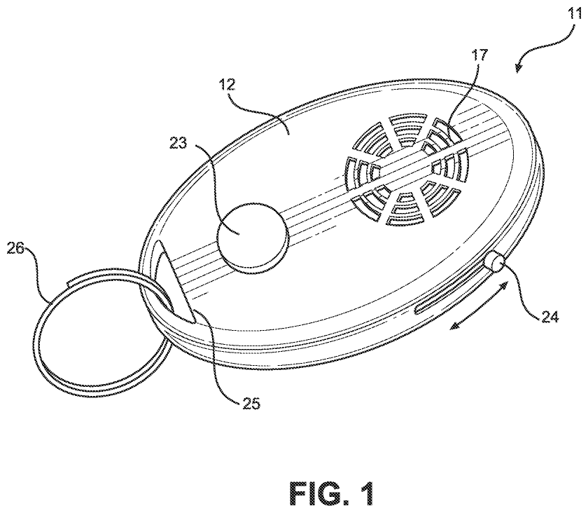

Referring now to FIG. 1, there is shown a perspective view of an embodiment of the mobile phone tracking device. The mobile phone tracking device 11 comprises a housing 12 having a speaker 17 and a control button 21 thereon. In the shown embodiment, the speaker 17 is visible, however, in other embodiments, the speaker 17 is internal and not visible on the exterior of the housing 12. In the illustrated embodiment, the housing 12 comprises an ovoid format similar to many existing key fob devices, however alternate form factors are contemplated to suit a user's preferences. Additionally, it is contemplated that the minimal form factor of the present housing 12 provides several benefits in ease of transport, such that a user can readily carry the housing 12 with them at all times with little to no inconvenience. In the shown embodiment, the housing 12 further comprises an aperture 25 therethrough, wherein the aperture 25 is configured to receive a key chain connector 26 therethrough. In this manner, the housing 12 is affixable to an existing keyring, such that the user can ensure the housing 12 is retained on their person with a commonly carried object.

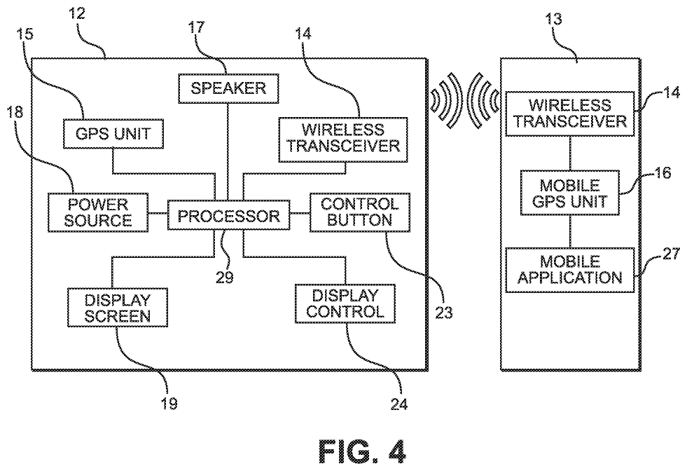

In operation, the housing 12 is configured to passively monitor a threshold separation distance between the housing 12 and a mobile device (as shown in FIG. 4, 13) as further described elsewhere herein. Upon detection of the housing 12 exceeding the threshold separation distance, the speaker 17 is configured to emit an audible alert. In this manner, the user can be immediately notified that they are leaving the vicinity of the mobile device such that the mobile device is not forgotten or misplaced. In the illustrated embodiment, the housing 12 further comprises a distance control 24 configured to selectively adjust a size of the threshold separation distance to allow the user to select the distance they may travel from the mobile device before the speaker 17 emits the audible alert to suit personal preferences. In the shown embodiment, the distance control 24 comprises a sliding switch disposed on a lateral side of the housing 12, however, in alternate embodiments, the distance control 24 can comprise a switch having multiple predefined positions associated with preset threshold distances. In some embodiments, the housing 12 operates in a passive mode automatically emitting an audible alert upon exceeding the threshold separation distance, whereas in alternate embodiments, the user can selectively activate the distance detection operation via actuation of the control button 23.

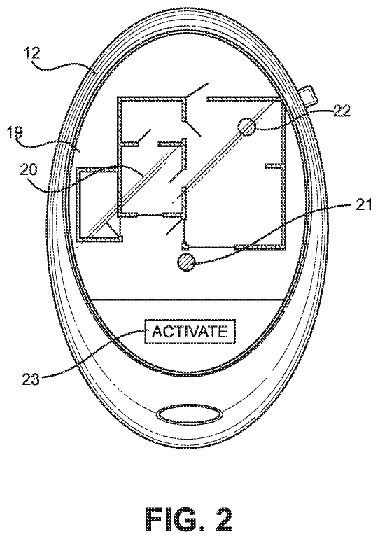

Referring now to FIG. 2, there is shown a front view of the display screen of an alternate embodiment of the mobile phone tracking device. In the illustrated embodiment, the housing 12 further comprises a display screen 19 thereon, wherein the display screen 19 is configured to display a map 20 of the present location when the control button 23 is actuated. In the shown embodiment, the control button 23 comprises a digital control displayed on a touch-sensitive display screen 19, however a physical control button 23 independent of the display screen 19 is similarly contemplated to preserve power when the display screen 19 is not in use. Similarly, the display screen 19 is configured to deactivate after a set amount of time elapses, allowing the housing 12 to further conserve power. In such embodiments, the display screen 19 may be further activated via contact, allowing the user to actuate the digital control button 23. In the illustrated embodiment, the map 20 further comprises a housing location indicator 21 showing the present location of the housing 12 as determined by a GPS unit (as shown in FIG. 4, 35) within the housing 12. Additionally, a mobile device indicator 22 is displayed on the map 20, wherein the location of the mobile device is determined by a mobile GPS unit (as shown in FIG. 4, 16) disposed within the mobile device. In this manner, the display screen 19 allows a user to locate the mobile device relative to the housing 12, such that when the user is alerted to having vacated the area with the mobile device, the user can readily retrieve the mobile device.

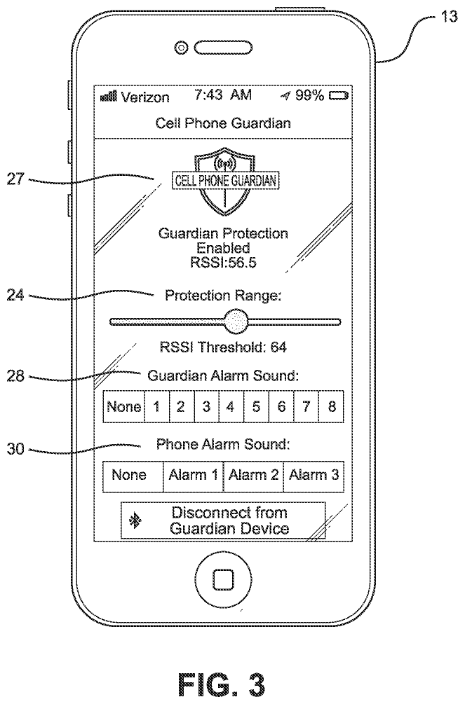

Referring now to FIG. 3, there is shown a front view of a mobile application associated with an embodiment of the mobile phone tracking device. In some embodiments, the housing 12 is operably connected to a mobile application 27 installed on the mobile device 13, wherein the mobile application 27 monitors the distance separating the mobile device 13 and the housing. In the shown embodiment, the mobile application 27 further comprises a distance control 24 thereon, wherein the user can selectively adjust the threshold separation distance to suit a user's preferences. In some embodiments, the threshold control 24 of the mobile application 27 comprises a distance indicium configured to show the currently set threshold separation distance. In embodiments utilizing the mobile application 27, the housing can be manufactured in a less complex manner to reduce cost and manufacturing requirements. In the illustrated embodiment, the mobile application 27 further comprises a sound selector 28 configured to allow a user to select the audible alert emitted from the speaker. In some such embodiments, the sound selector 28 comprises a drop-down selection having a plurality of preset audible alerts. In this manner, the user can personalize the audible alert according to user preferences. In the illustrated embodiment, the mobile application 27 further comprises a mobile device sound selector 30, wherein the mobile device sound selector 30 allows a user to select the audible alert emitted from the mobile device 13 upon detection of the housing exceeding the threshold separation distance.

Referring now to FIG. 4, there is shown a schematic view of an embodiment of the mobile phone tracking device. In the illustrated embodiment, the housing 12 comprises a central processor 29 operably connected to the GPS unit 15, the speaker 17, a power source 18, the display screen 19, the distance control 24, the control button 23, and a wireless transceiver 14. The wireless transceiver 14 operably connects the housing 12 to the mobile device 13 such that the GPS unit 15 and the mobile GPS unit 16 on the mobile device 13 are in communication to detect the distance between the housing 12 and the mobile device 13. In some embodiments, the processor 29 is configured to monitor the separation distance determined by the GPS units 15, 16, whereas, in other embodiments, the mobile application 27 monitors the separation distance. In such embodiments, the mobile application 27 allows the internal components of the housing 12 to be significantly simplified.

In operation, the housing 12 is carried by the user, such as while attached to an existing key ring. Upon the GPS units 15,16 detecting the separation distance between the housing 12 and the mobile device 13 exceeding the threshold separation distance, the speaker 17 emits an audible alert. In some embodiments, the user can actuate the distance control 24 to selectively adjust the size of the threshold separation distance such that the audible alert, is emitted at a desired distance. In this manner, the user can minimize the risk of false alarms that may occur due to moving from one location to another within the same room, for example. Once the user is alerted, the use can further actuate the control button 23 to activate the display screen 19 showing a map of the present location, allowing the user to pinpoint the exact location of the mobile device 13 relative to the housing 12 at which point the mobile device 13 can be retrieved. In this manner, misplacing or losing a mobile device, such as a phone, tablet, or the like can be avoided. Similarly, as keys can be easily misplaced, in some embodiments, the mobile device can emit an audible alert to inform the user of leaving the vicinity of the key ring associated with the housing 12. In this manner, the system can be utilized to remind the user of potentially misplacing either the housing 12 or the mobile device.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mobile phone location tracking device, comprising:
a housing having a wireless transceiver disposed therein, the wireless transceiver in operable communication with a mobile device;
a GPS unit within the housing, wherein the GPS unit is configured to operably connect to a mobile GPS unit disposed within the mobile device via the wireless transceiver to monitor a threshold separation distance between the mobile device and the housing;
whereupon detection that the housing has exceeded the threshold separation distance from the mobile device, a speaker within the housing emits an audible alert;
a power source disposed within the housing operably connected to each of the speaker, wireless transceiver, and the GPS unit.

2. The mobile phone location tracking device of claim 1, further comprising a display screen on the housing, wherein the display screen is configured to display a map showing a current location of each of the housing and the mobile device as determined by the GPS unit and the mobile GPS unit, respectively.

3. The mobile phone location tracking device of claim 2, further comprising a control button disposed on the housing, wherein the display screen is activated to display the map upon actuation of the control button.

4. The mobile phone location tracking device of claim 3, wherein the display screen comprises a touch-sensitive display, wherein the control button comprises a digital control button displayed on the display screen.

5. The mobile phone location tracking device of claim 1, further comprising a distance control disposed on the housing, wherein the distance control is configured to selectively adjust a size of the threshold separation distance.

6. The mobile phone location tracking device of claim 5, wherein the distance control comprises a sliding switch disposed on a lateral side of the housing.

7. The mobile phone location tracking device of claim 1, further comprising an aperture through the housing, wherein a key chain connector is disposed through the aperture.

8. A mobile phone location tracking device, comprising:
a housing having a wireless transceiver disposed therein, the wireless transceiver in operable communication with a mobile application installed on a mobile device;
a GPS unit within the housing, wherein the GPS unit is configured to operably connect to a mobile GPS unit disposed within the mobile device via the wireless transceiver;
wherein the mobile application is configured to monitor a threshold separation distance between the mobile device and the housing and send an alert signal to the housing upon detection of the housing exceeding the threshold separation distance;
a power source disposed within the housing operably connected to each of the speaker, wireless transceiver, and the GPS unit.

9. The mobile phone location tracking device of claim 8, further comprising a display screen on the housing, wherein the display screen is configured to display a map showing a current location of each of the housing and the mobile device as determined by the GPS unit and the mobile GPS unit, respectively.

10. The mobile phone location tracking device of claim 9, further comprising a control button disposed on the housing, wherein the display screen is activated to display the map upon actuation of the control button.

11. The mobile phone location tracking device of claim 10, wherein the display screen comprises a touch-sensitive display, wherein the control button comprises a digital control button displayed on the display screen.

12. The mobile phone location tracking device of claim S, further comprising a distance control disposed on the housing, wherein the distance control is configured to selectively adjust a size of the threshold separation distance.

13. The mobile phone location tracking device of claim 12, wherein the distance control comprises a sliding switch disposed on a lateral side of the housing.

14. The mobile phone location tracking device of claim 8, further comprising an aperture through the housing, wherein a key chain connector is disposed through the aperture.

15. The mobile phone location tracking device of claim 8, wherein the mobile application further comprises a distance control, wherein the distance control is configured to selectively adjust a size of the threshold separation distance.

16. The mobile phone location tracking device of claim 8, wherein the mobile application further comprises a sound selector, wherein the sound selector is configured to selectively adjust the sound of the audible alert emitted from the speaker of the housing.
